(19) United States
(12) Patent Application Publication
(10) Pub. No.: US 2007/0239600 A1
(43) Pub. Date: Oct. 11, 2007

(54) System and method for annuity processing

(76) Inventors: Steven W. Lundberg, Edina, MN (US); Pradeep Sinha, Medina, MN (US); Andrew William Bergstrom, Minneapolis, MN (US)

Correspondence Address: SCHWEGMAN, LUNDBERG & WOESSNER/CPA, P.O. BOX 2938, MINNEAPOLIS, MN, 55402, US

(21) Appl. No.: 11/401,155

(22) Filed: Apr. 10, 2006

(51) Int. Cl. G06Q 40/00; H04M 15/00

(52) U.S. Cl. 705/40; 705/34

(57) ABSTRACT

The present invention provides a system, apparatus, and method for annuity processing. In some embodiments, an annuity processing module is used in conjunction with an internet-based patent- and trademark-application management system. This annuity-processing module reflects a software implementation of various business rules or methods associated with paying the annuity due on a patent. These rules are, in some embodiments, derived from various laws relating to the payment of annuities. In some embodiments, these rules are provided to a workflow engine via a DTD or XML schema. The work-flow engine manages the execution of the various business rules and states associated with this execution. These rules, including the decision to make a payment, can be manually executed or automatically executed by a member of an organization implementing the annuity payment module as a part of a larger system. This larger application could, in some embodiments, be an internet-based patent- and trademark-application management system.

### CROSS REFERENCE TO RELATED APPLICATIONS

This application is related to the following applications: “INTERNET-BASED PATENT AND TRADEMARK APPLICATION MANAGEMENT SYSTEM”, Steven W. Lundberg, Inventor, Ser. No. 09/872,701, filed Jun. 1, 2001, which claims priority to “INTERNET-BASED PATENT AND TRADEMARK APPLICATION MANAGEMENT SYSTEM”, Ser. No. 60/280,386, filed Mar. 29, 2001; “INTERNET-BASED PATENT AND TRADEMARK APPLICATION MANAGEMENT SYSTEM”, Steven W. Lundberg, Inventor, Ser. No. 10/741,166, filed Dec. 17, 2003, which claims priority to “INTERNET-BASED PATENT AND TRADEMARK APPLICATION MANAGEMENT SYSTEM”, Ser. No. 60/433,935, filed Dec. 17, 2002; and “METHODS, SYSTEMS AND EMAILS TO LINK EMAILS TO MATTERS AND ORGANIZATIONS”, Sinha et al inventors, Ser. No. 10/128,141, filed Apr. 23, 2002 which claims priority to “A SYSTEM FOR SENDING AND RECEIVING ELECTRONIC MESSAGES IN AN ENTERPRISE MANAGEMENT SYSTEM”, Ser. No. 60/285,842, filed Apr. 23, 2001 and “SYSTEM, FUNCTIONAL DATA, AND METHODS FOR ON-LINE COLLABORATING USING MESSAGING, REPORTING, SECURITY, DOCKETING, BILLING, AND DOCUMENT MANAGEMENT”, Ser. No. 60/335,732, filed Oct. 18, 2001. The entire contents of the above cited applications are hereby incorporated herein by reference.

### FIELD OF THE INVENTION

This invention relates to the field of computer-implemented systems, methods, and an apparatus that allow for the processing and payment of annuities including annuities on patents as apart of a larger internet-based-patent-and-trademark-application-management system.

### LIST OF APPENDICES

An Appendix A containing a list of approximately 3662 source code files that make up one embodiment of the present invention is attached at the end of this application. These source code files are contain on a CD (i.e., Copy 1) that makes up part of Appendix A. A duplicate copy (i.e., Copy 2) of this CD is also contained in Appendix A. These source code files are incorporated by reference in their entirety into this application.

### COPYRIGHT NOTICE

This patent document contains copyrightable computer software elements including but not limited to source code, flow charts and screen displays. The following notice shall apply to these elements: “Copyright © FoundationIP, LLC”.

### LIMITED WAIVER OF COPYRIGHT

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights.

### BACKGROUND OF THE INVENTION

Patent agents and attorneys that specialize in patent or trademark prosecution typically draft dozens of patent or trademark applications per year, and are engaged in prosecution of many more. Each of these must be carefully tracked by the attorney or legal assistant, so that important status information such as potential bar dates, deadlines for response to office action amendments and responses, and other data are not overlooked. Management of this data has historically been managed by inclusion of each item on a docket that is tracked on paper docketing calendars, or more recently using commercially available electronic docketing software that serves the same purpose as a calendar. In addition, as more and more files are kept in electronic form it is challenging to provide access to those files in a way that preserves sensitive information from wide dissemination while allowing those with a need to know to view the information.

Of critical import in the tracking of legal documents, is the tracking of certain deadlines imposed by law. Certain deadlines relating to annuities are of critical importance. For example, under U.S. law patent annuity fees must be paid at intervals of three (3), seven (7) and eleven (11) years. (See 37 C.F.R. 1.362(d).) A patent holder has a six (6) month window during which they can tender this annuity fee. Upon the closing of this six month window, a payment can be made within a second six (6) month window so long as a surcharge payment is made as well. (See 37 C.F.R. 1.362(e).) If, however, this second six (6) month window is missed, the patent can go abandoned and a patent holder's ability to enforce a patent can be harmed in some cases by, for example, the intervening rights of another. Moreover, in some cases these rights can be lost all together, should the abandoned patent not be revived. What is needed is an internet based patent and trademark application management system that includes the ability to instruct third-party vendors such as Master Data Center (MDC), Computer Packages, Inc. (CPI) and others to make annuity payments.

### SUMMARY OF THE INVENTION

The present invention provides an apparatus, system, and method for instructing third-party vendors to make annuity payments as a part of a larger internet-based patent and trademark application management system. In some embodiments, the present invention allows a user to instruct others to make annuity payments via a graphical user interface (GUI) as embodied in a web browser. In some embodiments, the present invention implements a GUI displayed to a third-party annuity payment vendor, an annuity payment cycle (e.g., a fiscal quarter during which a number of annuity payments are due), the party who is charged with the responsibility of determining whether a payment should be made, the identity of the person (i.e., a corporation or others) who actually makes the payment, and information relating to whether the payment has been made, and the amount of payment. Moreover, in some embodiments, a user will be able to actually make the payment by merely executing a button, check box, link, or other type of interface that allows a user to implement a payment via a GUI. In some embodiments, a method making an annuity payment is implemented whereby a client computer receives notification that an annuity payment due, and, in response, initiates the sending of a payment instruction on a client computer through a GUI. In some embodiments, the present invention provides for the method further including extracting annuity data from an internet-based patent- and trademark-application management system, transmitting the extracted annuity data to a third-party vendor server computer, verifying the extracted annuity data against annuity data contained on the server computer, uploading a payment-decision list (PDL) to the client computer, extracting both the annuity data from the PDL and payment instructions, sending the annuity data and payment instructions to a server computer and making an annuity payment based upon the annuity data and the payment instructions, and uploading confirmation data and receipt data to the client computer (thus completing the payment instruction). In some embodiments, the server computer provides a payment channel. In some embodiments, the present invention resolves a discrepancy between the extracted annuity data, and the annuity data contained on a server is resolved by the client computer. In some embodiments, the present invention allows for the sending of annuity data and payment instructions to be performed manually by a user. In some embodiments, the present invention allows for the sending of annuity data and payment instructions to be performed automatically by a work-flow engine. In still further embodiments of the present invention, the method provides for a work-flow engine to receive a document type definition (DTD) schema, such that a payment channel is configured via the DTD schema.

In some embodiments, the present invention provides a computer-readable medium having instructions stored thereon for causing a suitably programmed computer to perform a method including: receiving on a client computer notification of an annuity payment due, initiating a payment instruction on a client computer through a GUI, extracting annuity data from an internet-based patent- and trademark-application management system, transmitting the extracted annuity data to a server computer, verifying the extracted annuity data against annuity data contained on the server computer, uploading a PDL to the client computer, extracting both the annuity data from the PDL and payment instructions, sending the annuity data and payment instructions to a server computer and making an annuity payment based upon the annuity data and the payment instructions, and uploading confirmation data and receipt data to the client computer (thus completing the payment instruction). In still further embodiments, the present invention provides for a computer-readable medium with a payment channel on the server computer. In some embodiments, the present invention provides for the computer-readable medium to resolve a discrepancy between the extracted annuity data and the annuity data contained on a server. In some embodiments, the present invention provides for the computer-readable medium to allow for the sending of annuity data and payment instructions to be performed manually by a user. In some embodiments, the present invention provides for a computer-readable medium that allows for the sending of annuity data and payment instructions to be performed automatically by a work-flow engine. In some embodiments, the present invention provides for the computer-readable medium to allow for payment channel configuration instructions to be provided to a work-flow engine via a DTD schema.

In some embodiments, the present invention provides a system for making annuity payments including a client computer operatively coupled to a server computer via an internet in a client-server configuration. In such a configuration, a client computer will receive notification of an annuity payment due, a GUI operatively coupled to the client computer will enable a user to initiate a payment instruction through the use of the GUI and, in response, a software module operatively coupled via an application programming interface (API) to an internet-based patent- and trademark-application management system will allow for annuity data to be extracted from the internet-based patent- and trademark-application management system, a software module operatively coupled via an API to the server computer that allows for the transmitting of data, a software module operatively coupled via an API to the server computer that allows for the annuity data to be verified, a software module operatively coupled via an API to the client computer that allows for uploading of a PDL, a software module operatively coupled via an API to the client computer that allows for the extracting of both PDL and payment instruction data, a software module operatively coupled via an API to the client computer that allows sending the annuity data and payment instructions to the server computer and making an annuity payment based upon the annuity data and the payment instructions, a software module operatively coupled via an API to the client computer that allows for uploading confirmation data and receipt data to be verified by the client computer, and a software module operatively coupled via an API to the client computer that allows for completion of the payment instruction. In some embodiments, a system is implemented involving resolving a discrepancy between the extracted annuity data and the annuity data contained on the server computer, with the discrepancy being resolved by the client computer. In some embodiments, the present invention provides a system wherein the sending of annuity data and payment instructions is initiated manually by a user. In some embodiments, the present invention provides a system wherein the sending of annuity data and payment instructions is performed automatically by a work-flow engine. In some embodiments, the present invention provides a system wherein the work-flow engine is provided with a DTD schema.

### BRIEF DESCRIPTION OF THE DRAWINGS

FIG. 1 describes a three-tier architecture scheme 100, as implemented in one embodiment of the present invention.

FIG. 2 is a GUI 200 describing among other things an Annuity Process Tab.

FIG. 3 is a GUI 300 describing among other things an Annuity Process Home-Payment Cycle Tab.

FIG. 4 is a GUI 400 describing among other things an Annuity Process Home-Entities Tab.

FIG. 5 is a GUI 500 describing among other things an Annuity Process Home-Personnel Tab.

FIG. 6 is a GUI 600 describing among other things an Annuity Process Home-Public Message Tab.

FIG. 7 is a GUI 700 describing among other things a Payment Cycle-Tasks Tab

FIG. 8 is a GUI 800 describing among other things a Payment Cycle-Decision List Tab.

FIG. 9 is a GUI 900 describing among other things a Payment Cycle-Discrepancy Tab.

FIG. 10 is a GUI 1000 describing among other things a Payment Cycle-Documents Tab.

FIG. 11 is a GUI 1100 describing among other things a Payment Cycle-Public Messages Tab.

FIG. 12 is a GUI 1200 describing among other things a Payment Cycle-Messages Tab.

FIG. 13 is a flow chart 1300 of the logical level for an annuity-payment module.

### DESCRIPTION OF EMBODIMENTS

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

### Overview of an Internet-Based Patent and Trademark Application Management System

In one embodiment of the invention, a web-based service provides a legal entity or a client or other affiliate of a legal entity access to data-management functions to facilitate legal proceedings. A law firm may utilize the web-based system to track data for a client, such as patent and trademark status, docketing, documentation, and billing.

In some embodiments, a client may be provided access to the web-based system, and when the client accesses the system they are offered account setup functions which when selected enable the client to utilize the system to perform various functions separate from and optionally visible to the law firm. For example, an invention disclosure management module may be a part of the web-based service that is utilized by the client, but invention disclosures entered into and managed by the system will not be visible to the law firm until they are released to the law firm's attention. The client may therefore use the web-based system to store invention disclosures and use them for evaluation, budgeting, awarding of inventor stipends, or for other functions that are not initially or may never be visible to the law firm, as well as to record disclosure information that is selectively or entirely released to the attention of the law firm or to any other law firm.

In some embodiments, invention disclosure management in further embodiments includes a function for receiving invention disclosures and for time-stamping receipt of received disclosures for date of invention record verification purposes. Also, the invention disclosure module may comprise a facility so that reviewers of an invention disclosure may electronically witness and sign an invention disclosure, such that the signature of the signing witnesses is further date-stamped with data indicating the date of electronic signing.

In at least one embodiment, the invention-tracking module is further operable to track potential bar dates relating to national and international filing, based on data entered relating to an offer for sale, public use, publication, or other activities relating to the invention. The module provides notice at various dates to the client of nearing potential bar dates, alerting the client to the potential bar date and the action that must be taken to ensure rights are not lost.

In some embodiments, the functions available to the client also include calendar- or date-tracking functions relating to various activities performed in the course of IP (intellectual property) management, such as invention disclosure meetings, attorney meetings, technical review board meetings, etc., and if applicable further track decisions or results of these meetings such as whether to pursue a patent application relating to a specific invention disclosure.

In some embodiments, one module of the web-based system usable for client data management comprises a data registry of various intellectual property held, such as records relating to trade-secret identification and retention, a record of various trademarks and their uses, and relevant registration or other legal information, and a patent-portfolio log indicating issued patents and their various characteristics, such as keyword and subject-classification data, such that a client may readily view and understand a record of his intellectual-property holdings. In a further embodiment of the invention, the web-based system comprises a module operable to search the data relating to these various intellectual-property assets, and to produce an intellectual-property report or audit.

In some embodiments, the client system includes a document system enabling creation or merging of various documents relating to intellectual-property matters. License agreements, assignments, non-disclosure agreements, and other such legal documents are examples of documents that may be useful to clients and are included in the various embodiments of the invention.

In some embodiments, the client's account data can be readily exchanged with the law firm via the web-management system in some embodiments, such that invention disclosure and potential bar date information relating to a case can be made available to the law firm once the decision to pursue a patent for a particular invention disclosure is made. In further embodiments, the web-based system provides issued patent or other reference search capability in various embodiments to the law firm and to the client for performing and documenting an electronic patentability search and review, so that results of a patentability search relating to an invention disclosure can be stored, and relevant documents recorded for preparation of an Information Disclosure Statement.

Further, in one embodiment, the law firm and the client are capable of exchanging other data via the web-based system, such as submission of a trademark, copyright, or trade-secret matter for various purposes, as well as capability to track and coordinate data relating to other matters such as opinion-related issues and work. In one embodiment of the invention, these various intellectual-property matters are identified to the client and to the law firm by a matter or activity identifier which need not be the same for both client and law firm, but which identify the same matter and enable identification and specification of data relating to the various matters in which the law firm and client are involved. In addition to matter identifier-based viewing of data, the web-based module in various embodiments comprises activity-based views in which an entity may view the various activities requiring attention for its various matters, may view all matters which have a certain activity pending, or may view another activity-based view of the intellectual-property matters under management.

In some embodiments of the invention, the web-based systems used by the client and the law firm are the same computerized system, while in other embodiments they are separate computerized systems but are operable to exchange data as appropriate for proper operation of the invention as described in the above various examples. In some embodiments where the same system is used, various forms of encryption are used to ensure the confidentiality of data as it travels over the Internet or other network. In embodiments where a separate computerized system is utilized by the client, the client may install and configure his own computerized system to host a local web-based system consistent with the present invention such that the client's confidential information such as trade-secret information and invention disclosures not released to external entities are held within systems under the client's control. Such systems will be able to exchange data with other computerized data-management systems under the client's direction, and so provide the various functions discussed in the example embodiments of the invention presented herein.

In some embodiments, the present invention can provide systems and methods for management of intellectual-property information, legal information, and/or patent and trademark applications. Various embodiments are described herein with reference to the Figures.

In some embodiments, the invention comprises a system for managing patent-application data via the Internet, and comprises matter, task, and security modules. The matter module is operable to manage data such as docketing data relating to patent matters, the tasks module is operable to manage tasks related to each matter managed by the matter module, and the security module is operable to restrict access to task- and matter data management to selected system users. The system is implemented in some embodiments as a World Wide Web site on the Internet, which in further embodiments comprises various components such as an application server, a Java server, and a database.

### A Three-Tier Architecture

In some embodiments, the present invention can be thought of as a distributed or non-distributed software application designed under a three-tier software architecture paradigm, whereby the various modules of computer code that make up the present invention can be categorized as belonging to one or more of these three tiers. A three-tier software architecture is well known in the art. (See Applying UML and Patterns: An Introduction to Object-Oriented Analysis and Design and the Unified Process 2nd Edition, by Craig Larman, Prentice Hall, 2002.) The first tier is an Interface level that is relatively free of application processing. The second tier is a Logic level that performs processing in the form of logical/mathematical manipulations (Logical Manipulations) of data inputted, in some embodiments, through the Interface level, and communicates the results of these manipulations with the Interface and/or backend or Storage level. In some embodiments, these Logical Manipulations relate to certain business rules or tasks that govern the application as a whole. In some embodiments, these Logical Manipulations and associated business rules include: the purging of messages in a legal information system, the auto-filing of a result in an IP management system, the obtaining and disseminating of secured on-line data, generating work flow templates, regulating the export control of technical documents, the bulk downloading of documents, billing, creating and managing matter clusters, configuring certain activities, managing independent docket systems, prior art cross citations, and exchanging public and private messages, just to name a few. The Storage level is a persistent, or, in some embodiments, a non-persistent storage medium. In some embodiments, one or more of these tiers is collapsed into another, resulting in a two-tier architecture, or one-tier architecture. For example, the Interface and Logic levels may be consolidated, or the Logic and Storage levels may be consolidated, as in the case of an application with an embedded database. This three-tier architecture may be implemented using one technology or, as will be discussed below, a variety of technologies. These technologies may include one or more object-oriented programming languages such as, for example, Java™, C++, Delphi™, C#™, or the like. Additional structured programming languages such as, for example, C may also be used. Moreover, scripting languages such as, for example, Perl, Python, PHP, JavaScript or VBScript may also be used. This three-tier architecture, and the technologies through which it is implemented, in some embodiments, can be implemented in two or more computers organized in a server-client relationship, as is well known in the art, such that an Interface level resides on a client computer, whereas the Logic level resides on the application server (see below) and the Storage level resides on a database server (see below). (See Computer Networking: A Top-Down Approach Featuring the Internet 2nd Edition, James F. Kurose and Keith W. Ross, Addison-Wesley, 2003.) Put another way, in some embodiments, these three levels may be distributed between more than one computer.

### An Interface Level

In some embodiments, the present invention is implemented using a client-based browser application. Some well-known client-based browser applications include the Netscape Browsers™, Internet Explorer™, Mozilla Firefox™, or Opera™, just to name a few. Common to these browser applications, is the ability to utilize a hyper-text transfer protocol (HTTP) or secured hyper-text transfer protocol (HTTPS) to get, upload (i.e, PUT) or delete web pages and interpret these web pages which are written in a hyper-text markup language (HTML) and/or an extensible-markup language (XML). HTTP and HTTPS are well known in the art, as are HTML and XML. (See id. XML for the World Wide Web, by Elizabeth Castro, Peachpit Press, 2000; Data on the Web: From Relations to Semistructured Data and XML 1st Edition, by Serge Abiteboul, Peter Buneman, & Dan Suciu, Morgan Kaufmann, 1999.) HTTP and HTTPS are, in some embodiments, used in conjunction with a TCP/IP protocol as described in the OSI model, or the TCP Protocol Stack model, both of which are well known in the art. (See Computer Networking: A Top-Down Approach Featuring the Internet 2nd Edition, James F. Kurose and Keith W. Ross, 2003.) The practical purpose of the client-based browser application is to enable a user to interact with the application through the display of plain text, and/or interactive, dynamic functionality in the form of buttons, text boxes, scroll down bars or other objects contained on one or more web pages constructed using the aforementioned HTML and/or XML.

Web pages are typically static or dynamic in nature. Those that are static typically display text as one would see it on a printed, physical page. Dynamic web pages, however, are interactive and allow for a user to input data, query data, and/or modify data just to name a few of the functionalities associated with dynamic web pages. The dynamic nature of web pages, in some embodiments, is a product of the use of other technologies in combination with HTML and/or XML.

In some embodiments, Java Server Pages (JSP™), or Active Server Pages (ASP™ or ASP.NET™) (collectively server pages) are used to provide a user with dynamic web pages or content via their web browser. In some embodiments, additional technology in the form of an additional program (i.e, a routine) written in another programming language is embedded into the HTML and/or XML code, allowing for the web pages to become dynamic. Some of these additional technologies include, for example, embedded routines written in the Java™ programming language, the Java Script language, or the Visual Basic™ programming language, just to name a few. In some embodiments, these embedded routines are used to execute the aforementioned HTTP, HTTPS requests (i.e., GET, PUT, and DELETE) for web pages. Various types of programming structures such as branches, loops and other types of logic structures are used in such routines. These routines may, in some embodiments, allow a user to login, and request content or upload content.

In some embodiments, for example, a GUI is used and is implemented via a Java Servlet, Applet, or VBScript form, just to name a few. As will be discussed below, web pages containing GUIs are, in some embodiments, stored at the Logical level, but executed at the Interface level via a web browser. These server pages contain objects such as text boxes, buttons, scroll-down bar, just to name few. These objects, and the routines governing them, allow a user to retrieve, input, or delete content, just to name a few of the functions. For example, in some embodiments a user will be prompted with a login page requesting username and password information to be entered into two or more text boxes. Once the data entered into the text boxes is verified, a second, new web page will be requested, interpreted and displayed in the browser application. The verification of the login information would take place at the Logic level outlined below.

### A Logic Level

In some embodiments, the above-described Servlets, Applets and/or VBScript forms are stored as a JSP™, or ASP™ on one or more remote server computers connected to the client computer via an internet. These remote servers can, in some embodiments, be a web server and/or application server. In some embodiments, web servers running JSP™ can include the Apache™/Apache™ Tomcat web server. In some embodiments, web servers running ASP™ can include Microsoft Windows Web Server 2003™. In some embodiments, application servers running JSP™ can include an Orion Application Server, or J2EE™ Application Server, just to name a few. In some embodiments, application servers running ASP™ can include Windows Server 2003™.

In some embodiments, the Logic level is governed by a scripting language that controls how and when certain web pages or pieces of content are provided to, or made accessible to a particular user. This scripting language can be in the form of Java™, Perl, Python or some other general purpose scripting language. For example, once the logic of a JSP™ determines that a particular object (e.g., a text box) on web page has been executed (e.g., a username and password is entered and sent), the data from this text box is inputted, sent to the web or application server. In some embodiments, it is the logic of a routine written in a scripting language that determines what will be sent to the user upon the successful verification of the username and password. In some embodiments, it is the routine written in a scripting language that determines whether, for example, the username and password are valid. In some embodiments, the routine written in a scripting language will serve to retrieve data from a storage, data structure or database level. In some embodiments, the storage level will be a run by a separate database application, while in other embodiments a database embedded with a Logical level will be implemented.

### A Storage Level

In some embodiments, a storage level is implemented whereby tables of data are created, and data is inserted into, or selected from, these tables using a structured query language (SQL) or some other database-related language known in the art. (See The Fundamentals of Database Systems 3rd Edition, by Remez Elmasri & Shamkant B. Navathe, Addison-Wesley, 2000.) These tables of data can be managed using a database applications such as, for example, MySQL™, SQL Server™, or Oracle 9i™ or 10g™, just to name a few. These tables, in some embodiments, are organized into a relational-database schema (RDS) or object-relational-database schema (ORDS), as is known in the art. (See id.) In some embodiments, these schemas can be normalized using certain normalization algorithms so as to avoid abnormalities such as non-additive joins and other problems. In some embodiments, these normalization algorithms include Boyce-Codd Normal Form or some other normalization, optimization algorithm known in the art. (See id.) For example, in some embodiments, username and associated password information are stored together such that the scripting routine can compare the inputted, received username and password information to that data stored in the database.

### An Architectural Diagram

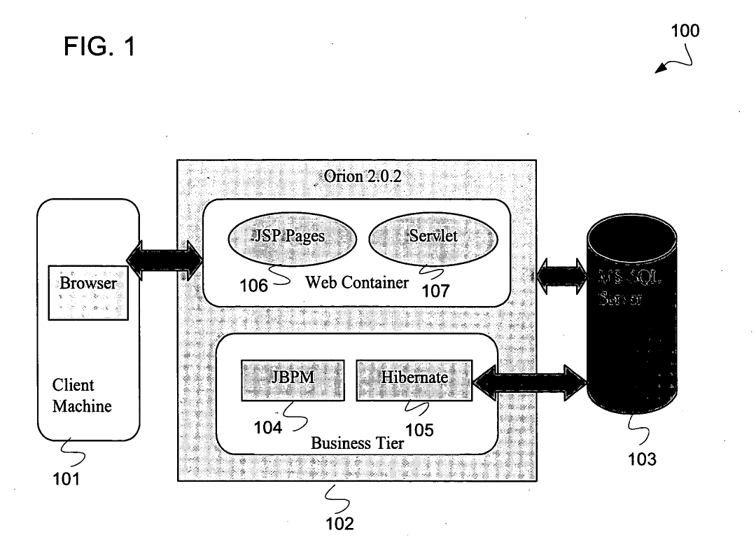

FIG. 1 describes a three-tier architecture scheme 100 as outlined above, and as implemented in one embodiment of the present invention. An interface level 101 is a client machine that utilizes a web browser or browser, as described above, to allow a user to interface with the present invention. This interface level 101 is, in turn, connected to a logic level 102. In at least one embodiment of the present invention, this logic level contains a java application server with JSP's 106 and Servlets 107. These JSP's 106 and Servlet's 107 are controlled through, in some embodiments, a driver program or work-flow engine that makes calls to the java application server. In at least one embodiment, this work-flow engine is a Java Business Process Management (JBPM) 104 engine. Also depicted is a Hibernate object relational mapping module 105. In at least one embodiment, this logical level 102 is connected to a storage level 103, as outlined above, which, in at least one embodiment, is a data base application such as SQL Server™.

### An Annuity-Payment Module

In some embodiments, an annuity-payment module written in one of the above-described object-oriented programming languages is implemented. In one embodiment, this module can be implemented using component-oriented or object-oriented programming techniques such as a Visual Component Library (VCL), Component Library for Cross Platform (CLX), Java Beans (JB), Java Enterprise Beans (EJB), or Component Object Model (COM), just to name a few. Typically these modules are linked to another program via various APIs and then compiled into one complete server and/or client application. The process for using modules in the building of client and server applications is well known in the art. (See Component Based Software Engineering: Putting the Pieces Together, by George T. Heineman and William T. Council, Addison-Wesley, 2001; Delphi Component Design, by Danny Thorpe, Addison-Wesley, 1996.). In the present invention, an annuity payment module is written using one of the above-described techniques in conjunction with an object-oriented programming language and is compiled together with an internet-based-patent-and-trademark-application-management system, thus providing additional functionality to this system.

### An Interface Level Related to an Annuity-Payment Module

In some embodiments, as described above, a GUI displayed via a browser is implemented to allow a user to interact with one embodiment of the present invention. In some embodiments, this GUI is implemented with the above-described JSP's or other technologies utilized at the interface level. (See Interface level outlined above.)

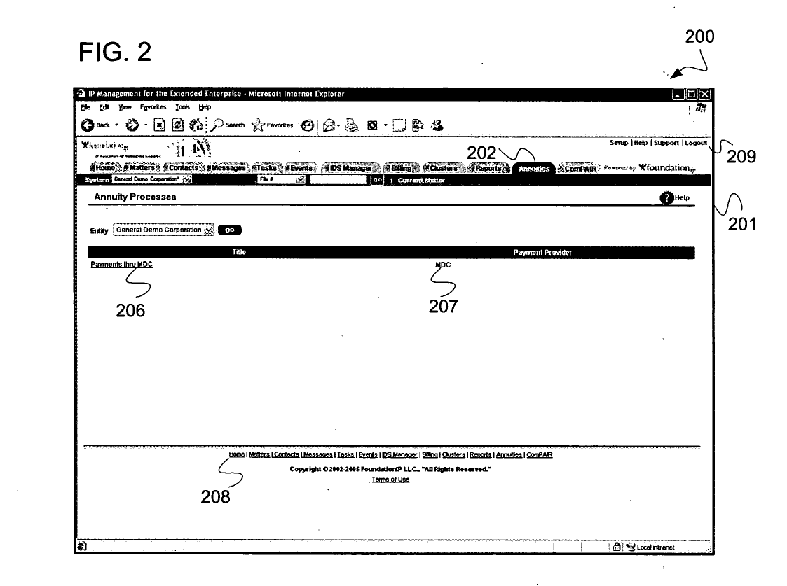

FIG. 2 is a GUI 200 describing among other things an Annuity Process Tab. In some embodiments, a tab, scroll down menu or other GUI based object is used to allow a use to access an annuity page. In FIG. 2, a browser 201 is used to provide a user with a GUI. The user selects a tab 202 displayed in the GUI to enable them to access an annuity page. In addition, tabs 208 are displayed that allow a user to return to a home page, or traverse through different functionalities of the system for the management of legal documents including going to a contact page, billing page and matter page just to name a few. Further, functionality relating to enabling the user to log out of the internet-based-patent-and-trademark-application-management system, help and other functionality are depicted in the group of buttons collectively labeled as 209.

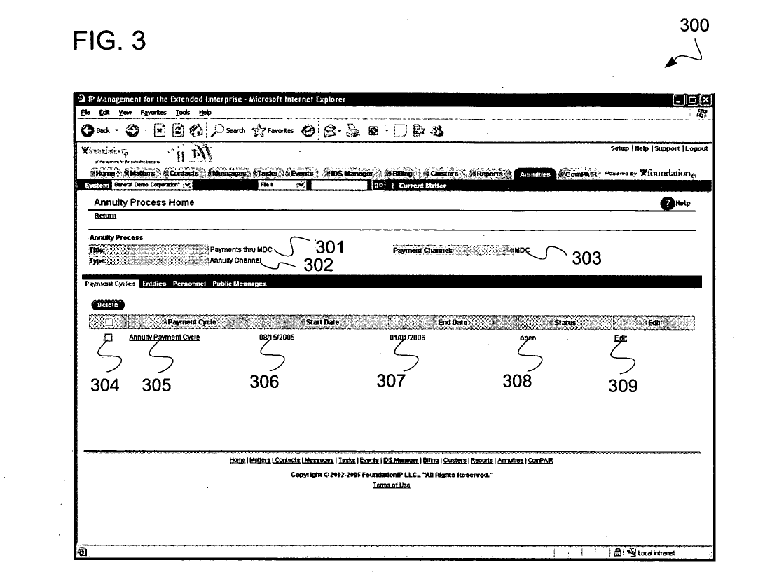

FIG. 3 is a GUI 300 describing among other things an Annuity Process Home-Payment Cycle Tab. In some embodiments, a GUI is displayed that allows a user to see the time period defining a particular payment cycle. In some embodiments, a payment-cycle GUI is implemented that depicts an annuity-process field with a title 301, a type 302, and the company making the payment on the annuity (i.e., a payment channel) 303. Also depicted in this GUI is a delete option 304 for deleting the annuity entry, a payment-cycle heading 305, and the beginning of the payment cycle (i.e., a start date) 306, closing of the payment cycle (i.e., an end date) 307, a status field describing the status of the payment cycle (i.e., whether it is open or closed), and an edit function 309 that allows a user to edit the annuity entry. In some embodiments, the delete option 304 is implemented via a check box, radio button, drop-down menu, text box, or some other object. In some embodiments, the payment-cycle heading contains entries in the form of hyper links to other web pages describing a history of the payment cycle itself.

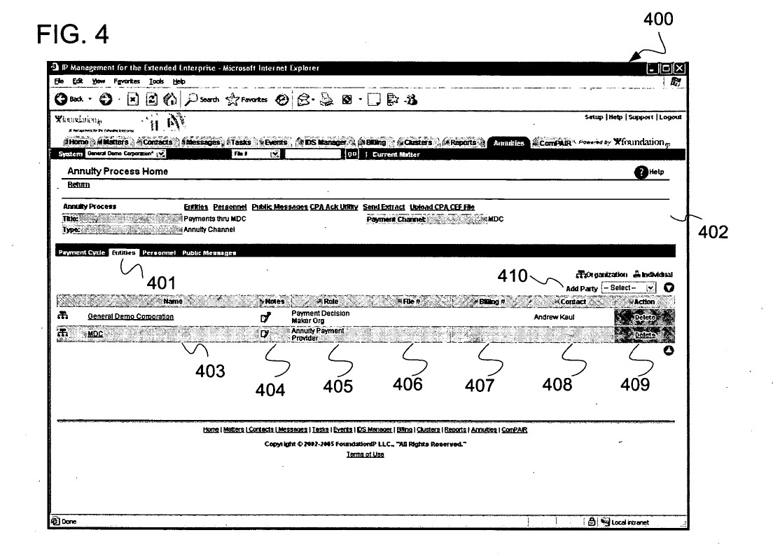

FIG. 4 is a GUI 400 describing among other things an Annuity Process Home-Entities Tab. In some embodiments, an entities tab is implemented that, when executed, describes the organization that is charged with the responsibility of making a payment, and the third-party annuity payment vendor. Depicted in this GUI 400 is an entities tab 401, an annuity process home 402 with a number of text fields relating to title, type and payment channel (see 301, 302, 303 respectively). Additionally, a name field 403 is depicted that, in some embodiments, allows a user to execute hyper links connected to the additional web pages containing data relating to the organization that is charged with the responsibility of making a payment, and the third-party annuity payment vendor. Also described is a notes field 404 containing an executable icon of a note that allows a user to both read and modify text-based notes providing information relating to, for example, the annuity payment, the third-party annuity payment vendor and other such information. In some embodiments, a role field 405 is provided to describe the roles of the persons listed under the name field 403. In some embodiments, a file # field 406 is provided wherein a file or matter number is displayed. In one embodiment, a billing # field 407 is displayed in which information relating to a billing number for the matter is displayed. Still in at least one embodiment, a contact field 408 is depicted wherein a contact name is provided for each person listed under the names field 403. Additionally, in some embodiments, a delete link 409 is displayed that allows an entry to be deleted, assuming that user has the particular privileges to execute this link.

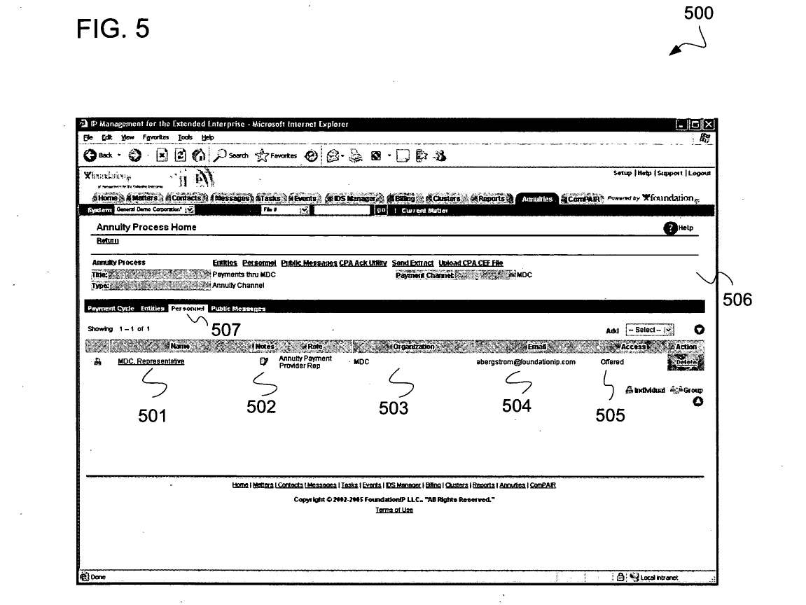

FIG. 5 is a GUI 500 describing among other things an Annuity Process Home-Personnel Tab. In some embodiments, depicted in this GUI 500 is an annuity process home 506 with a number of text fields relating to title, type and payment channel (see 301, 302, 303 respectively). Additionally, in some embodiments, a personnel tab 507 is highlighted to allow one to see what tab has been selected. In the present example, the Personnel tab has been selected. In some embodiments, a number of data fields are provided once this personnel tab 507 is selected. For example, in at least one embodiment, a name field 501 is displayed containing a hyper link to a page containing contact information for individuals at the payment provider. In some embodiments, a notes field 502 is provided that allows notes regarding a particular contact at a payment to provider to be stored. A role field (depicted but not referenced) is also described that allows the role of this contact within the payment process to be listed. Next, in some embodiments, an email contact address field 504 is listed. Further, in some embodiments, an access field 505 is listed describing, for example, whether the contact individual at the payment provider has access to the internet-based patent- and trademark-application management system. This access field 505 may, in some embodiments, denote additional functionality.

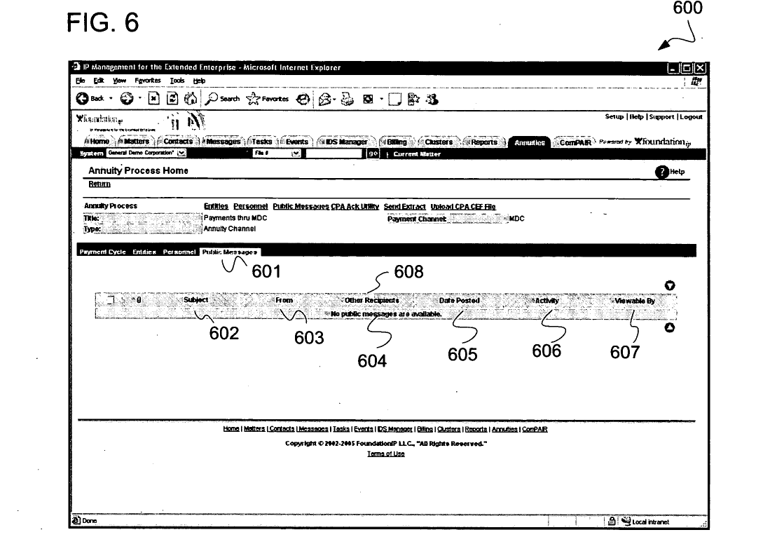

FIG. 6 is a GUI 600 describing among other things an Annuity Process Home-Public Message Tab. Depicted in this GUI 600 is a public massage tab 601 that instructs a user as to what-page the user is viewing. In some embodiments, emails are exchanged between the organization and payment providers, and, in some embodiments, these emails are displayed as messages. As described elsewhere, this tab 601 and others (e.g., 401, 507) allow a user to navigate from web page to web page. This GUI 600 also contains a variety of data fields relating to, for example, a subject 602 (describing the subject line of a message), a from 603 (describing who the message is from), a prompt 604 (instructing the user that no messages are present, or providing specific message information), a date posted field 605 (describing the date on which the message was posted), an activity field 606 (describing what activity needs to be undertaken in regard to the message), and a viewable by field 607 (describing who has viewed the message).

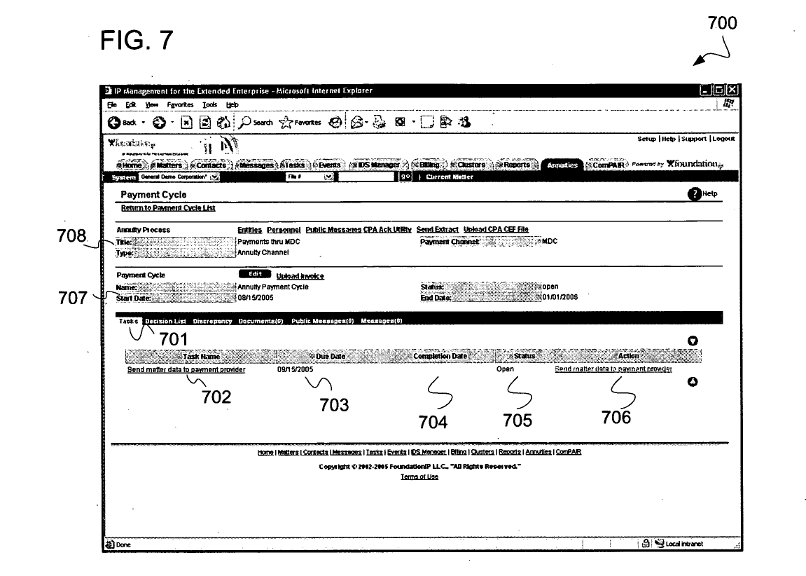

FIG. 7 is a GUI 700 describing among other things a Payment Cycle-Tasks Tab. In some embodiments, this GUI 700 allows a user to track a payment cycle, and as discussed below such information as when the annuity payment was made, when it was due, and allows a user to actually instruct a third-party annuity payment vendor to make a payment. In some embodiments, these instructions take the form of an email sent to the third-party annuity payment vendor instructing them with regard to payment. In some embodiments, this email contains data (e.g., a matter number, patent number) extracted for the purpose of instructing the third-party annuity payment vendor with regard to payment. In some embodiments, a grouping of various text fields relating to title, type and payment channel (see 301, 302, 303 respectively) are depicted. Collectively these fields are referenced as an annuity process field 708. In at least one embodiment, a payment cycle field 707 is illustrated that contains fields relating to the name of the start date (i.e., the opening of the payment cycle), end date (i.e., the closing of the payment cycle) and the status, for a particular payment cycle. These fields are illustrated but not referenced in the present GUI 700. In at least one embodiment, a task tab 701 is highlighted that allows a user to navigate from web page to web page. Other tabs depicted but not referenced include, for example, a decision list tab, discrepancy tab, a documents tab, a public massages tab (that denotes the number of messages), and a messages tab (that also denotes the number of messages), including, in some embodiments, private messages. A task name field 702 is also depicted containing a hyper link to allow a user to execute a task (see section below titled Logic level Related to An Annuity Payment Module). In some embodiments, the tasks depicted under the task name field 702 include tasks remaining to be performed for a particular payment cycle. In some embodiments, a due date field 703 listing the due date for an annuity payment is also depicted. Additionally, in some embodiments, a completion date field 704 is also described denoting when a payment process was completed by date. Moreover, in some embodiments, a status field 705 is also depicted describing the status as open (i.e., that the annuity still needs to be paid) or, in some embodiments, closed (i.e., that the annuity has been paid). In some embodiments, the status of other tasks such as, for example, the uploading of a PDL, and the need to send payment instructions is also listed. In some embodiments, these tasks vary in relation to the requirements of the third-party annuity payment vendor. In some embodiments, an action field 706 is also illustrated that allows a user to initiate payment in a payment cycle through the use of a hyper link.

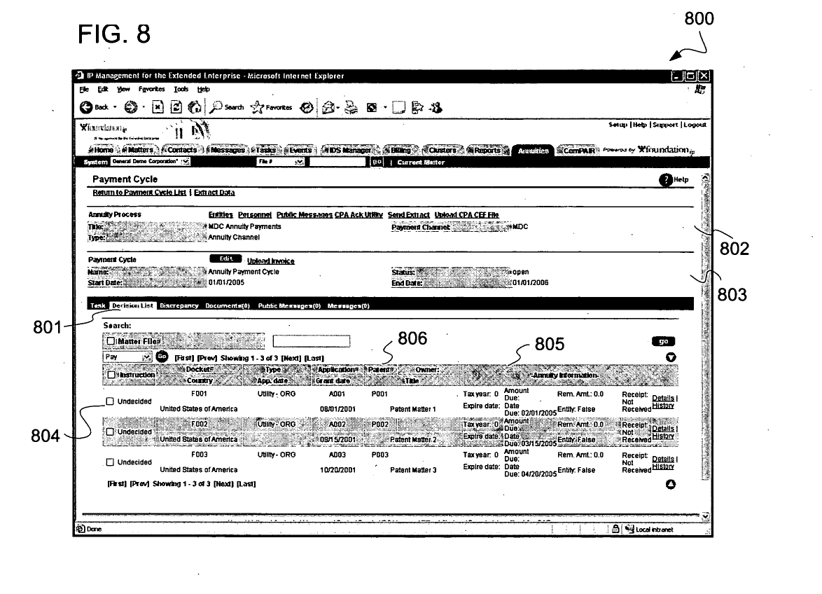

FIG. 8 is a GUI 800 describing among other things a Payment Cycle-Decision List Tab. In some embodiments, a user is given the option of highlighting specific annuities that they wish to instruct a third-party annuity payment vendor to pay. In some embodiments, a GUI 800 is provided that allows for a user to see a variety of open matter requiring annuity payments. In some embodiments, a decision list tab 801 is highlighted that once executed allows a user to view a web page relating to annuity matters for which a payment decision must be made. In some embodiments, as described above, a grouping of various text fields relating to title, type and payment channel (see 301, 302, 303 respectively) are depicted. Collectively these fields are referenced as an annuity process field 802. In at least one embodiment, a payment cycle field 803 is illustrated that contains fields relating name of the start date (i.e., the beginning of the payment cycle), end date (i.e., the ending of the payment cycle) and the status. These fields are illustrated but not referenced in the present GUI 800. In some embodiments, a variety of date fields are depicted that, among other things, for example, allows a user to view multiple matters for which annuity payments must be made. In at least one embodiment, these fields include: an instruction field, docket/country field, type/app. date field, application#/grant date field, patent# field 806, owner:/title field, and an annuity information field 805. Some fields depicted in FIG. 8 are depicted, but not referenced. In some embodiments, the instruction field contains a number of entries related to particular matters for which decisions regarding the payment of annuities must be made. For example, in one embodiment, a check box 804 is implemented that allows a user to modify the decision regarding whether to pay an annuity. In some embodiments, if this check box 804 is executed, then the annuity matter will be kept active and the user will be prompted with this entry each time they view this GUI 800.

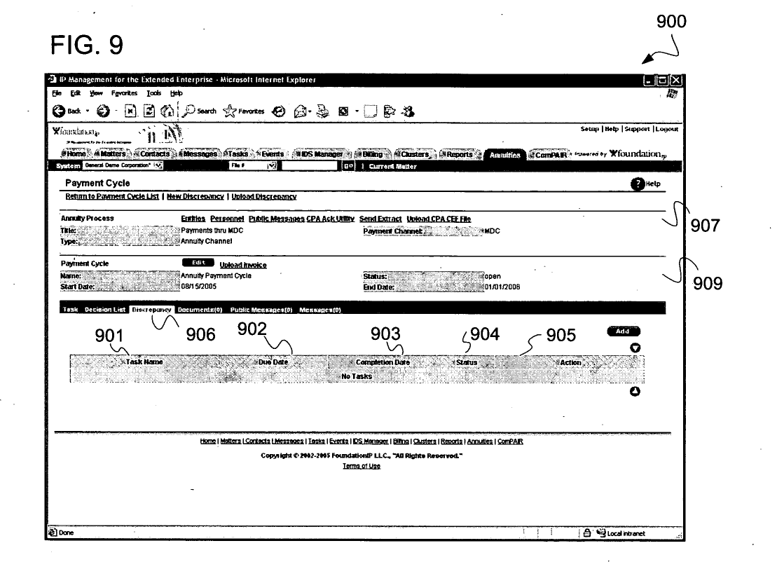

FIG. 9 is a GUI 900 describing, among other things, a Payment Cycle-Discrepancy Tab. In some embodiments, a GUI 900 is provided to allow a user to determine if discrepancies exist between the payment history data contained in the internet-based patent- and trademark-application management system, and the payment channel. This functionality is more fully described below. (See section below titled Logic level Related to An Annuity Payment Module.) In some embodiments, as described above, a grouping of various text fields relating to title, type and payment channel (see 301, 302, 303 respectively) are depicted. Collectively these fields are referenced as an annuity process field 907. In at least one embodiment, a payment cycle field 909 is illustrated that contains fields relating name of the start date (i.e., the beginning of the payment cycle), end date (i.e., the ending of the payment cycle) and the status. These fields are illustrated, but not referenced, in the present GUI 900. In some embodiments, a discrepancy tab 906 is depicted that allows a user to navigate to a web page containing discrepancy data. In some embodiments, a variety of data fields are depicted including, for example, a task name field 901 (depicting the name of the annuity task for which there is a discrepancy), due date field 902 (illustrating the due date of the annuity task), a completion date field 903 (illustrating the date the annuity task was completed), a status field 904 (illustrating the status of the present annuity task such as being open or closed), and an activity field 905 (denoting when the last activity for the annuity matter occurred).

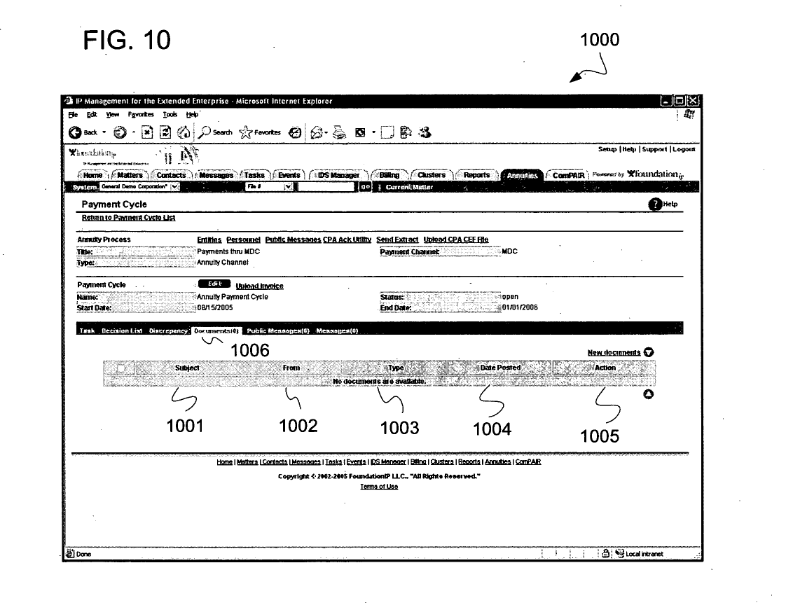

FIG. 10 is a GUI 1000 describing among other things a Payment Cycle-Documents Tab. In some embodiments, a documents tab 1006 is depicted that allows a user to navigate to the GUI 1000, through clicking on this tab. In some embodiments, this GUI contains data related to documents relevant for the purpose of making an annuity payment. Contained in this GUI 1000 is a variety data fields, including, for example, a subject field 1001 (denoting the subject of a particular document entry), a from date field 1002 (denoting who a document is from), a type data field (described but not referenced), an entry field 1003 (denote where documents would be listed) m a date posted field 1004 (denoting when the document was posted), and an action field 1005 (denoting what actions, if any have been taken with respect to the document).

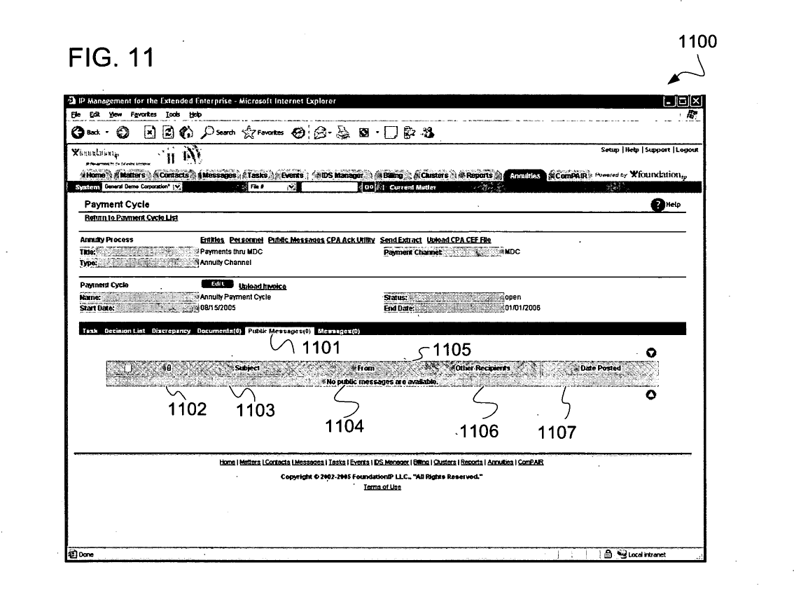

FIG. 11 is a GUI 1100 describing among other things an Payment Cycle-Public Messages Tab. In some embodiments, a public messages tab 1101 is implemented that allows for a user to traverse through a variety of web pages using tabs. As described elsewhere some additional example tabs in the GUI 1100 include, a payment cycle tab, an entries tab, and a personnel tab. In some embodiments, this public messages tab 1101 will denote the number of messages available. In addition to the public message tab 1101, also depicted is attachment field 1102 denoted by paper clip icon. This attachment field 1102 displays documents attached to a public message. Next, in some embodiments, a subject data field 1103 is illustrated that allows the subject of a message to be denoted. Additionally, in some embodiments, a from data field 1105 is provided telling who the message is from. Furthermore, in some embodiments, an other recipient's data field 1106 is depicted. This field allows for other recipients of the message to be denoted. In some embodiments, a message field 1104 is displayed listing the message, or if no messages are present, a prompt stating that no messages are present. In at least one embodiment, a date posted field 1107 is listed denoting the date when a message was posted.

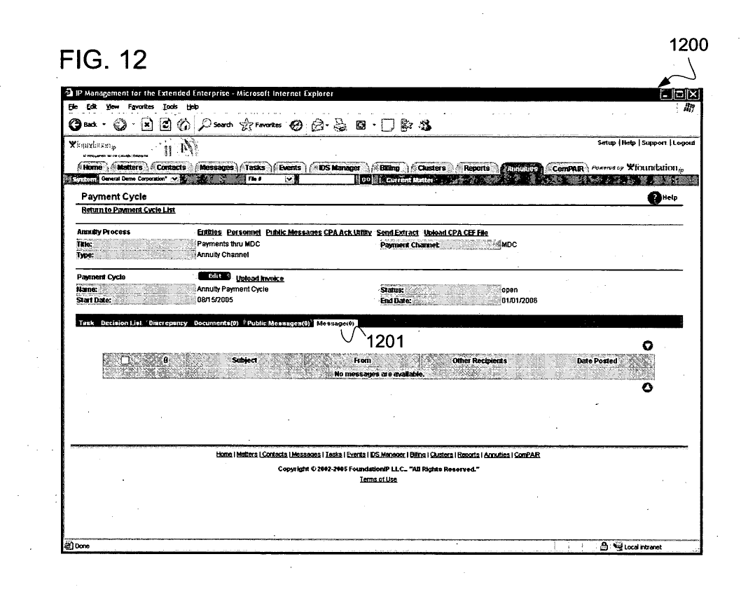

FIG. 12 is a GUI 1200 describing among other things an Payment Cycle-Messages Tab. In some embodiments, a GUI 1200 is implemented wherein private messages can be exchanged between users of this invention. In at least one embodiment, a message tab 1200 is displayed that allows a user to traverse from one screen to another including being able to traverse to a screen displaying private messages exchanged between user relating to annuity payments. In some embodiments, this GUI 1200 contains much of the same functionality as GUI 1100 including, for example, an attachment field 1102, a subject data field 1103, a from data field 1105, a recipient's data field 1106, a message field 1104 and, a date posted field 1107 is listed denoting when the date when a message was posted.

### A Logic Level Related to an Annuity-Payment Module

In some embodiments, as described above, a logical level is implemented that follows certain business rules, which are, in turn, implemented via software. In some embodiments, this logical level is implemented using the above outlined technology relating to a logic level. (See Logic level outlined above.) These technologies include, in some embodiments, an Orion Application Server™, or J2EE™ server just to name a few. As described above, in some embodiments, the logic underlying this level can be written in an object-oriented programming language as is known in the art, while individual libraries that make up this application may be called using a scripting language as is described above. In some embodiments, a work-flow engine is implemented such as a JBPM 104 engine. This engine is passed an instruction set (i.e., channel configuration information) that instructs the JBPM 104 engine on the steps or logic that must be followed in making an annuity payment. This channel configuration information can, in some embodiments, take the form of a DTD schema or XML schema in the form of a file. (See XML for the World Wide Web, by Elizabeth Castro, Peachpit Press, 2000; Data on the Web: From Relations to Semistructured Data and XML 1st Edition, by Serge Abiteboul, Peter Buneman, & Dan Suciu, Morgan Kaufmann, 1999.) In some embodiments, once this channel configuration information is passed to the JBPM 104 engine, additional XML based data may be passed to the engine to update the engine on the state of the steps being executed by the annuity payment module. Once a step is complete, the JBPM 104 engine will provide additional instructions to the annuity payment module. The following is an example DTD schema providing channel configuration information to the JBPM 104 engine:

<!ELEMENT Bcc (Recipient)>
<!ELEMENT BlockNum (#PCDATA)>
<!ELEMENT Cc (Recipient)>
<!ELEMENT ChannelConfig (ChannelContactInfo, MatterCriteria,
DataExtract, PaymentInstructionExtract, DiscrepancyResolution,
PaymentCycles)>
<!ATTLIST ChannelConfig CDATA #REQUIRED>
<!ELEMENT ChannelContactInfo (ChannelOrgName,
ChannelOrgEmail)>
<!ELEMENT ChannelOrgEmail (#PCDATA)>
<!ELEMENT ChannelOrgName (#PCDATA)>
<!ELEMENT Criterion (FilterData)>
<!ELEMENT CustomBlock (#PCDATA)>
<!ELEMENT Cycle (#PCDATA)>
<!ATTLIST Cycle CDATA #REQURED>
<!ELEMENT DataExtract (CustomBlock, SendTo)>
<!ELEMENT DiscrepancyResolution (CustomBlock, SendTo)>
<!ELEMENT Email (To, Cc, Bcc, Subject, body)>
<!ELEMENT EndDate (#PCDATA)>
<!ELEMENT Field (#PCDATA)>
<!ELEMENT FilterData (FilterElementData | LogicalOperator)+>
<!ELEMENT FilterElementData (Field, BlockNum?, Operator, Val)>
<!ELEMENT LogicalOperator (#PCDATA)>
<!ELEMENT MatterCriteria (Criterion)>
<!ELEMENT Operator (#PCDATA)>
<!ELEMENT PaymentCycle (Cycle, StartDate, EndDate)>
<!ELEMENT PaymentCycles (PaymentCycle)>
<!ELEMENT PaymentInstructionExtract (CustomBlock, SendTo)>
<!ELEMENT Recipient (#PCDATA)>
<!ATTLIST Recipient CDATA #REQUIRED>
<!ELEMENT SendTo (Email)>
<!ELEMENT StartDate EMPTY>
<!ELEMENT Subject (#PCDATA)>
<!ELEMENT To (Recipient)>
<!ELEMENT Val (#PCDATA)>
<!ELEMENT body (#PCDATA)>

In some embodiments, an additional payload field in a DTD or XML schema may contain, for example, an additional instruction set for the JBPM 104 engine. In some embodiments, these payload fields can be nested such that one field and payload is contained in another field and payload. The following a DTD schema covering the additional payload functionality, and an actual XML example implementing this DTD schema is provided as follows:

<!ELEMENT event (header, target*, payload)>
<!ATTLIST event type CDATA #REQUIRED>
<!ELEMENT header (descriptor)*>
<!ELEMENT target (descriptor)*>
<!ELEMENT descriptor ( #PCDATA )>
<!ATTLIST descriptor name (organization|matter|activity|task)
#REQUIRED
type (id|serial-number|patent-number|file-number) #REQUIRED>
<!ELEMENT payload ANY>

An example XML implementation using the payload DTD schema:

<?xml version=“1.0”?>
<Event type=“PAIR”>

<Header>

<Descriptor name=“Organization” type=“id”> </Descriptor>

</Header>
<Target>

<Descriptor name=“Matter” type=“id”>
</Descriptor> <Descriptor name=“Activity” type=“id”>
</Descriptor>
<Descriptor name=“Task” type=“id”> </Descriptor>

</Target>
<Target>

<Descriptor name=“Matter” type=“id”> </Descriptor>
<Descriptor
name=“Activity” type=“id”>
</Descriptor> <Descriptor name=“Task” type“id”>
</Descriptor>

</Target>
<Payload> </PayLoad>

</Event>

In some embodiments of the present invention, a second DTD schema is used to configure the Logic level 102. In some embodiments, a DTD schema is provided to the Logic level 102 to configure it for a particular matter, and/or owner of this matter. More to the point, in some embodiments of the present invention, the patent owner would like to have the functionality described in the DTD configured for a particular matter, and/or patent owner.

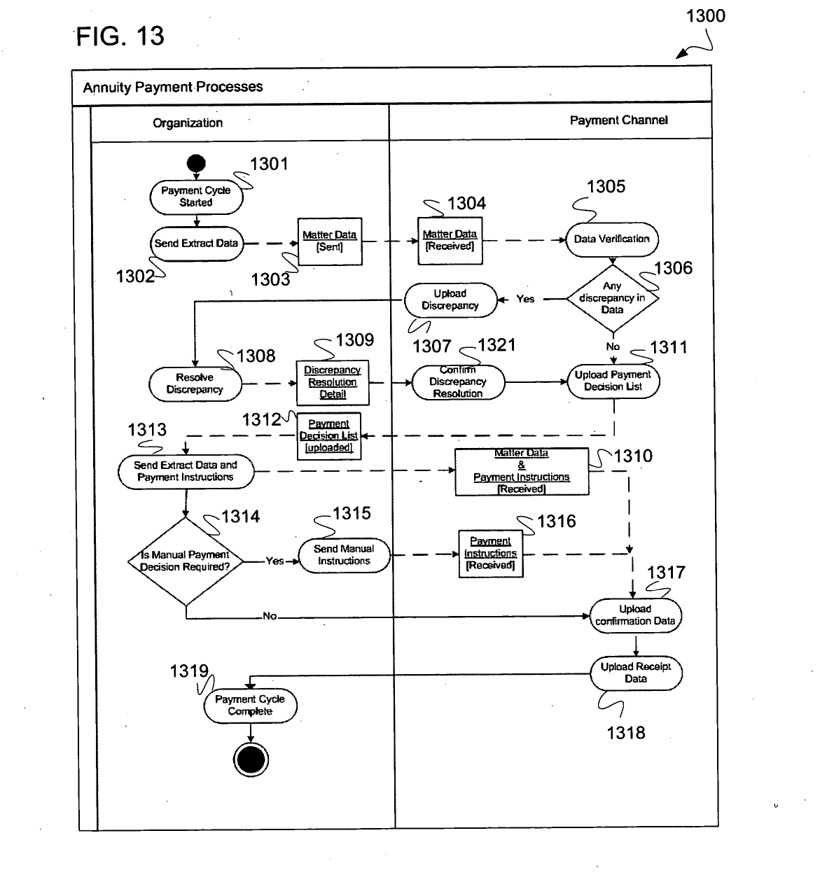

FIG. 13 is a flow chart schema (flow chart) 1300 of the logical level for an annuity payment module. Described within this flow chart are processes and terms used to define these processes. Included in these terms are the following. An annuity, which as described above, is a payments of a certain sum of money to be made at regular intervals for the renewal of patents. A payment cycle which is one complete cycle of providing payment instructions, making payments and receiving confirmation on those payments. In a particular payment cycle, payments are done for the matters whose annuity payment's due date lies between the start date and end date of a payment cycle. Additionally, a payment cycle task will be created under the Payment Cycle activity, providing a way to take advantage of the system for managing legal documents pre-existing ability to send out email reminders and to assign tasks to individuals. This email ability, functionality is common to many such internet-based patent- and trademark-application management systems. A payment channel is disclosed which is the organization (channel) through which annuity payments are made. A payment decision maker is the individual or individuals at the host organization who can access the channel's payment cycles, send extracted data and make decisions on payments. A channel representative is the contact at the payment channel that the host organization interfaces with. The channel representative operates on behalf of the payment channel to provide annuity payment information to the host organization. Moreover, a payment channel requires, in some embodiments, that the internet-based patent- and trademark-application management system calculate the proper annuity tax information and do the actual payments.

In additional to the above-described terms and functionalities, various payments instructions can be provided by the user. These instructions can be provided in an automated manner or manually. A payment instruction is a decision made by the organization regarding actual payment or non-payment of the annuity. This information also needs to be extracted from the internet-based patent- and trademark-application management system and sent to the channel after the payment decisions have been made. In one embodiment, the payment decision maker can modify the instructions after the payment instructions for annuities have been sent to the channel. In such a case, the payment decision maker can re-send the instructions via email to the channel representative notifying them of the modified decision.

In some embodiments, annuity related data will be uploaded and manipulated by the system. For example, in one embodiment, the channel representative will upload various types of data into internet-based patent- and trademark-application management system. In some embodiments, each upload is associated with a particular payment cycle. This provides a way for the channel to update internet-based patent- and trademark-application management system with data generated by the channel. In some embodiments, the internet-based-patent-and-trademark-application management system is updated with a PDL which contains information related to when annuities are due and how much annuity or tax is owed. The payment channel uploads the PDL to the internet-based patent- and trademark-application management system. The host organization will use this information to make decisions. Terms related to a PDL include: Discrepancy Data—discrepancy data is a record of any inconsistencies that the channel provider has found with the data received from the internet-based patent- and trademark-application management system. The channel representative verifies the extracted matter data that the payment channel has received and uploads discrepancy data, if any, into internet-based patent- and trademark-application management system; Confirmation Data—a record of the actual amount paid for the annuities due in a particular payment cycle; Receipt Data—a record of information about the receipts received for the paid annuities in a particular payment cycle.

As described above FIG. 13 is a flow chart 1300 of the logical level for an annuity payment module. As depicted in FIG. 13, the annuity payment process can be broken into two (2) parts: the part or role of the organization, and that of the payment channel. The annuity payment process begins with a member of an organization starting a payment cycle 1301 by selecting an annuity tab 202, and then a hyper link 702. Once the hyper link 702 is selected, a process is executed 1302 wherein a command is sent to the annuity payment module to send extracted data 1303 to the payment channel. This extracted data 1303 is received by the third-party annuity payment vendor as extracted data 1304. The data sent includes matter information and information relating to the actual file, or matter covering the item (e.g., a patent) on which a payment must be made. Once the extracted data 1304 is received, a data verification process 1305 is executed wherein the above-described payment cycle and associated dates (i.e., 306 and 307) are confirmed. If the there is a discrepancy 1306 between data (i.e., yes or true is determined), then a discrepancy process 1307 is initiated wherein the user is put on notice as to the discrepancy. A discrepancy can take the form of a difference, for example, between the matter data cited by an organization, and the matter data cited by the third-party annuity payment vendor. In still further embodiments, a discrepancy can take the form of matter data that is missing for the purposes of the third-party annuity payment vendor. In some embodiments, a process 1308 is implemented such that a user is asked to resolve this discrepancy, through a discrepancy resolution detail 1309. (See FIG. 9 above (displaying a GUI 900 used to resolve such discrepancies).) Once the discrepancy is resolved, a process 1321 is implemented to confirm the resolution. An alternative branch of execution from the discrepancy 1306 (i.e., a no or false is determined) results in a process 1311 to upload a PDL. The result of process 1321 also results in this process 1311. Once the process 1311 is executed, a PDL is uploaded 1312 to the organization. After the PDL is uploaded 1312, a process 1313 is executed wherein the PDL can be viewed by the user, and a decision made as to whether an annuity payment should be made on an individual matter. (See FIG. 8 above (displaying a GUI 800 used to make payment determinations).) In some embodiments, the decision to make a payment is made automatically (i.e., a member of the organization reviews the payment decision list, and makes payment decisions (see e.g., FIG. 8).). In still further embodiments, the decision to make a payment is manually (i.e., a change to the automatically made payments, wherein an override notification is sent to the third-party annuity payment vendor instructing them to disregard the previous automatic instruction, and to pay or not pay the annuity (see FIG. 8.).) determined. In some embodiments, a manual payment branch 1314 is implemented. In some embodiments, the manual payment branch is set to yes or true, and a process 1315 is executed whereby a manual payment instructions regarding individual matters is sent to the payment channel. In some embodiments, as described below, various upload confirmation 1317 and upload receipt 1318 processes are executed. In instances where the payment process is automated and the manual branch is set to no or false, an alternative branch of execution from process 1313 extracts the data and payment instructions and send them to the payment channel to make the actual payment. In the case of the branch 1314 being true or false, a process 1317 is executed wherein payment confirmation data is uploaded, and then a process 1318 is executed wherein receipt data is uploaded by the payment channel denoting that an annuity payment has been made. In some embodiments, this receipt data includes, for example, date, time, matter number, and amount of payment. Once processes 1317 and 1318 are completed, a process 1319 is executed wherein the state of the payment cycle is complete.

In some embodiments, the present invention provides a method for making an annuity payment is implemented whereby a client computer receives notification of an annuity payment due, and in response initiates a payment cycle on a client computer through a GUI. In some embodiments, the present invention provides for the method further including extracting annuity data from an internet-based patent- and trademark-application management system, transmitting the extracted annuity data to a server computer, verifying the extracted annuity data against annuity data contained on the server computer, uploading a PDL to the client computer, extracting both the annuity data from the PDL and payment instructions, sending the annuity data and payment instructions to a server computer and making an annuity payment based upon the annuity data and the payment instructions, uploading confirmation data and receipt data to the client computer, and completing the payment cycle. In some embodiments, the present invention provides that the server computer is a payment channel. In some embodiments, the present invention provides a method for resolving a discrepancy between the extracted annuity data, and the annuity data contained on a server to be resolved by the client computer. In some embodiments, the present invention provides for the sending of annuity data and payment instructions is performed manually by a user. In some embodiments, the present invention provides allows for the sending of annuity data and payment instructions to be performed automatically by a work-flow engine. In still further embodiments, the present invention provides a method wherein the work-flow engine is provided an instruction set. In some embodiments, the present invention provides for payment cycle data to be provided via a GUI.

In some embodiments, the present invention provides a computer-readable medium having instructions stored thereon for causing a suitably programmed computer to perform a method including receiving on a client computer notification of an annuity payment due, initiating a payment cycle on a client computer through a GUI, extracting annuity data from an internet-based patent- and trademark-application management system, transmitting the extracted annuity data to a server computer, verifying the extracted annuity data against annuity data contained on the server computer, uploading a PDL to the client computer, extracting both the annuity data from the PDL and payment instructions, sending the annuity data and payment instructions to a server computer and making an annuity payment based upon the annuity data and the payment instructions, and uploading confirmation data and receipt data to the client computer (thus completing the payment cycle). In still further embodiments, the present invention provides for the computer-readable medium, and instructions contained thereon, to create a payment channel on the server computer. In some embodiments, the present invention provides that the computer-readable medium, and instructions contained thereon, resolve a discrepancy between the extracted annuity data, and the annuity data contained on a server. In some embodiments, the present invention provides that the computer-readable medium, and instructions contained thereon, allow for the sending of annuity data and payment instructions to be performed manually by a user. In some embodiments, the present invention provides a computer-readable medium, and instructions contained thereon, for allowing for the sending of annuity data and payment instructions to be performed automatically by a work-flow engine. In some embodiments, the present invention provides for the computer-readable medium, and instructions contained thereon, to allows for instructions to be provided to a work-flow engine. In some embodiments, the present invention provides for the computer-readable medium, and instructions contained thereon, to allow for the payment cycle to be initiated via a GUI.

In some embodiments, the present invention provides a system for making annuity payments over an internet including a client computer configured to receive notification that an annuity payment is due, a GUI operatively coupled to the client computer that enables a user to initiate a payment cycle through the use of the GUI, a software module operatively coupled via an API to an internet-based patent- and trademark-application management system that allows for annuity data to be extracted from the internet-based patent- and trademark-application management system, a software module operatively coupled via an internet connection to the server computer that allows for the transmitting of data, a software module operatively coupled via an API to the server computer the allows for the annuity data to be verified, a software module operatively coupled via an API to the client computer that allows for uploading of a PDL, a software module operatively coupled via an API to the client computer that allows for the extracting of both PDL and payment instruction data, a software module operatively coupled via an API to the client computer that allows for sending the annuity data and payment instructions to the server computer and making an annuity payment based upon the annuity data and the payment instructions, a software module operatively coupled via an API to the client computer that allows uploading confirmation and receipt data to be provided to the client computer, and a software module operatively coupled via an API to the client computer that allows for the completion of the payment cycle. In some embodiments, the present invention provides for a system to be implemented wherein the server computer provides a payment channel. In some embodiments, the present invention provides for a system to be implemented involving resolving a discrepancy between the extracted annuity data and the annuity data contained on the server computer, with the discrepancy being resolved by the client computer. In some embodiments, the present invention provides for a system to be implemented wherein the sending of annuity data and payment instructions is initiated manually by a user. In some embodiments, the present invention provides for a system to be implemented wherein the sending of annuity data and payment instructions is performed automatically by a work-flow engine. In some embodiments, the present invention provides for a system to be implemented wherein the work-flow engine is provided an instruction set.

In some embodiments, the present invention provides a method that includes receiving, on a client computer, notification of an annuity payment due, initiating a payment cycle on the client computer, extracting annuity data from an internet-based patent- and trademark-application management system, transmitting the extracted annuity data to a server computer, verifying the extracted annuity data against annuity data contained on the server computer, uploading a PDL to the client computer, and sending the extracting data and payment instructions to a server computer. In some embodiments, the present invention provides for a server computer to be owned by a payment channel. In some embodiments, the present invention provides for discrepancies between the extracted annuity data and the annuity data contained on the server computer to be resolved by either the client or server computers. In some embodiments, the present invention provides for the sending of the annuity data and payment instructions to be initiated manually by a user. In some embodiments, the present invention provides for the sending of the annuity data and payment instructions to be performed automatically by a work-flow engine. In some embodiments, the present invention provides for the work-flow engine to be provided an instruction set. In some embodiments, the present invention provides for a method wherein the payment cycle is initiated via a GUI.

In some embodiments, the present invention provides a computer-readable medium having instructions stored thereon for causing a suitably programmed computer to perform a method including: receiving, on a client computer, notification of an annuity payment due, initiating a payment cycle on the client computer, extracting annuity data from an internet-based patent- and trademark-application management system, transmitting the extracted annuity data to a server computer, verifying the extracted annuity data against annuity data contained on the server computer, uploading a PDL to the client computer, and sending extracting data and payment instructions to a server computer. In some embodiments, the present invention provides for a server computer to be owned by a payment channel. In some embodiments, the present invention provides for the instructions stored on the computer readable medium to allow for discrepancies between the extracted annuity data and the annuity data contained on the server computer are resolved by the client computer or the server computer. In some embodiments, the present invention provides for the sending of annuity data and payment instructions to be initiated manually by a user. In some embodiments, the present invention provides for the instructions stored on the computer readable medium to allow for the sending of annuity data and payment instructions to be performed automatically by a work-flow engine. In some embodiments, the present invention provides for the instructions stored on the computer readable medium to allow for the work-flow engine to be provided an instruction set. In some embodiments, the present invention provides for the instructions to be stored on the computer readable medium to allow for initiating the payment cycle via a GUI.

In some embodiments, the present invention provides a system including, a first computer configured to receive instructions from second computer is implemented, wherein the instructions are inputted via a GUI, a first software module operatively coupled to an internet-based patent- and trademark-application management system wherein the first software module extracts data from the internet-based patent- and trademark-application management system residing on the first computer, a second software module operatively coupled to the internet-based patent- and trademark-application management system that transmits the extracted data via an internet, a third software module operatively coupled to the internet-based patent- and trademark-application management system that allows for uploading of a PDL, and a fourth software module operatively coupled to the internet-based patent- and trademark-application management system that transmits the extracted data and payment instruction data. In some embodiments, the present invention provides a software module operatively coupled to the internet-based patent- and trademark-application management system is implemented that resolves data discrepancies. In some embodiments, the present invention provides a system wherein these discrepancies are resolved by the first computer, while in other embodiments of the present invention, these discrepancies are resolved by the second computer. In some embodiments, the first computer is operatively coupled via the internet to a third computer owned by a payment channel. In some embodiments, the present invention provides for the transmitting of the data and the payment instructions data to be initiated manually by a user. In some embodiments, the transmitting of data and the payment instructions data is performed automatically by a work-flow engine. In some embodiments, the present invention provides a system wherein the work-flow engine is provided with an instruction set.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

What is claimed is:

1. A method comprising:
receiving, on a client computer, notification of an annuity payment due;
initiating a payment cycle on the client computer;
extracting annuity data from an internet-based patent- and trademark-application management system;
transmitting the extracted annuity data to a server computer;
verifying the extracted annuity data against annuity data contained on the server computer;
uploading a PDL to the client computer; and
sending extracting data and payment instructions to a server computer.

2. The method of claim 1, wherein the server computer is owned by a payment channel.

3. The method of claim 1, further comprising resolving a discrepancy between the extracted annuity data and the annuity data contained on the server computer.

4. The method of claim 1, wherein the sending of the annuity data and payment instructions is initiated manually by a user.

5. The method of claim 1, wherein the sending of the annuity data and payment instructions is performed automatically by a work-flow engine.

6. The method of claim 5, further comprising providing the work-flow engine an instruction set.

7. The method of claim 1, further comprising initiating the payment cycle via a GUI.

8. A computer-readable medium having instructions stored thereon for causing a suitably programmed computer to perform a method comprising:
receiving, on a client computer, notification of an annuity payment due;
initiating a payment cycle on the client computer;
extracting annuity data from an internet-based patent- and trademark-application management system;
transmitting the extracted annuity data to a server computer;
verifying the extracted annuity data against annuity data contained on the server computer;
uploading a PDL to the client computer; and
sending extracting data and payment instructions to a server computer.

9. The computer-readable medium having instructions stored thereon for causing a suitably programmed computer to perform the method of claim 8, wherein the server computer is owned by a payment channel.

10. The computer-readable medium having instructions stored thereon for causing a suitably programmed computer to perform the method of claim 8, wherein the method further comprises resolving a discrepancy between the extracted annuity data and the annuity data contained on the server computer.

11. The computer-readable medium having instructions stored thereon for causing a suitably programmed computer to perform the method of claim 8, wherein the sending of annuity data and payment instructions is initiated manually by a user.

12. The computer-readable medium having instructions stored thereon for causing a suitably programmed computer to perform the method of claim 8, wherein the sending of annuity data and payment instructions is performed automatically by a work-flow engine.

13. The computer-readable medium having instructions stored thereon for causing a suitably programmed computer to perform the method of claim 12, wherein the method further comprises providing the work-flow engine an instruction set.

14. The computer-readable medium having instructions stored thereon for causing a suitably programmed computer to perform the method of claim 8, wherein the method further comprises initiating a payment cycle via a GUI.

15. A system comprising:
a first computer configured to receive instructions from second computer, wherein the instructions are inputted via a GUI;
a first software module operatively coupled to an internet-based patent- and trademark-application management system wherein the first software module extracts data from the internet-based patent- and trademark-application management system residing on the first computer;
a second software module operatively coupled to the internet-based patent- and trademark-application management system that transmits the extracted data via an internet;
a third software module operatively coupled to the internet-based patent- and trademark-application management system that allows for uploading of a PDL; and
a fourth software module operatively coupled to the internet-based patent- and trademark-application management system that transmits the extracted data and payment instruction data.

16. The system of claim 15, further comprising a software module operatively coupled to the internet-based patent- and trademark-application management system that resolves data discrepancies.

17. The system of claim 15, wherein the first computer is operatively coupled via the internet to a third computer owned by a payment channel.

18. The system of claim 15, wherein the transmitting of the data and the payment instructions data is initiated manually by a user.

19. The system of claim 15, wherein the transmitting of data and the payment instructions data is performed automatically by a work-flow engine.

20. The system of claim 15, wherein the work-flow engine is provided with an instruction set.
